(19) United States
(12) Patent Application Publication
(10) Pub. No.: US 2023/0365892 A1
(43) Pub. Date: Nov. 16, 2023

(54) COMPOSITIONS AND METHODS USING SOIL RELEASE POLYMERS

(71) Applicant: Church & Dwight Co., Inc., Princeton, NJ (US)

(72) Inventor: Andrew Guttentag, Robbinsville, NJ (US)

(73) Assignee: Church & Dwight Co., Inc., Princeton, NJ (US)

(21) Appl. No.: 18/029,291

(22) PCT Filed: Sep. 29, 2021
(86) PCT No.: PCT/US21/52515

§ 371 Date: Mar. 29, 2023

Related U.S. Application Data
(60) Provisional application No. 63/085,512, filed on Sep. 30, 2020.

(51) Int. Cl. C11D 3/00; C11D 3/37; D06M 15/53; D06M 16/00; C11D 3/10

(52) U.S. Cl. CPC C11D 3/0036; C11D 3/3707; D06M 15/53; D06M 16/00; C11D 3/10; D06M 2200/01

(57) ABSTRACT

Various compositions are provided for use with textiles, the compositions including at least a soil release polymer. The composition may be, for example, a laundry detergent composition comprising at least one surfactant, at least one builder, a soil release polymer, and an aqueous base. The disclosure further provides methods for improving performance of textiles, and such methods can comprise treating the textile with a composition including a soil release polymer such that at least hydrophilicity of the textile is increased.

### FIELD OF INVENTION

The present invention relates to compositions for use in treating textiles, particularly fabrics, and more particularly performance clothing items. The compositions can be applied in a variety of manners and can improve one or more properties of the treated textiles.

### BACKGROUND

There is an increasing popularity of so-called “performance” textiles, clothing, or apparel, such performance items being understood to be items that perform or function for some particular purpose, such as to help keep active people cool, comfortable, and dry by wicking moisture away from the skin. Because performance clothing items are typically worn during strenuous activity, such items are more prone to developing odors associated with transfer of bacteria from the human body to the clothing and thus require frequent laundering. Such frequency of laundering, however, can also tend to reduce the performance attributes of the clothing items by removing materials that are originally present in the clothing fabric to impart hydrophilicity and wicking ability to inherently hydrophobic materials. Frequent laundering and daily wear can likewise abrade performance fabrics exhibiting wicking ability and cause significant reductions or substantially complete loss of wicking ability.

Many advances in laundering compositions and techniques have been achieved in the past, but the increasing popularity of performance clothing and the unique challenges in maintaining proper function of these often expensive items remains a problem in relation to simultaneously maintaining good hygiene. Accordingly, there remains a need in the art for compositions, including detergent compositions, that can be effective for not only removing dirt and odors, but also for maintaining performance textiles in their optimum state and even improving performance of clothing items not originally configured to provide such abilities.

### SUMMARY OF INVENTION

The present disclosure provides a variety of compositions that can be useful for improving one or more performance characteristics of a textile, particularly clothing items. The compositions can be provided in a variety of forms and can provide performance improvement alone or in combination with laundering capabilities. As such, the compositions may be provided as laundry detergents or as stand-alone products that can be applied directly to a particular clothing item separate from a laundering process. Improvements in performance can be evidenced by a variety of factors, such as improving wettability of the textile, improving hydrophilicity of the textile, improving wicking ability of the textile, reducing bacterial adhesion to the textile, reducing malodor from the textile, and the like. Likewise, when provided as a laundry composition, the present formulations can impart one or more of such performance improvements in combination with typical removal of soil and the like from the textile.

In one or more embodiments, the present disclosure can particularly provide methods for improving performance of a textile. Such methods can comprise treating the textile with a composition including a soil release polymer in an amount effective to modify hydrophilicity of the textile. Improved hydrophilicity can be evidenced, for example, by at least one of the following: prior to said treating, the textile exhibits a wicking rate of less than 10 mm²/second and, after said treating, the textile exhibits a wicking rater of greater than 10 mm²/second when tested utilizing AATCC 198: Test Method for the Horizontal Wicking of Textiles; and prior to said treating, the textile exhibits a water contact angle of greater than 90 degrees and, after said treating, the performance textile exhibits a water contact angle of less than 90 degrees. In further embodiments, such methods may be defined in relation to one or more of the following statements, which may be combined in any number and order.

The soil release polymer can be a poly(ethyleneoxide)-based polymer.

The poly(ethyleneoxide)-based polymer can be a copolymer of polyethylene terephthalate and polyoxyethylene terephthalate.

The soil release polymer can be present in the composition in an amount of about 0.1% to about 10% by weight based on the total weight of the composition.

The composition can comprise an aqueous base in an amount of about 1% to about 45% by weight based on the total weight of the composition.

The composition can comprise an aqueous base in an amount of about 50% to about 99% by weight, based on the total weight of the composition.

The textile can be made from a composition that is substantially hydrophobic, and the treating can be effective to impart hydrophilicity to at least a portion of the textile as evidenced by, prior to said treating, the textile exhibiting a wicking rate of less than 10 mm²/second and, after said treating, the textile exhibiting a wicking rate of greater than 10 mm²/second when tested utilizing AATCC 198: Test Method for the Horizontal Wicking of Textiles.

The textile can be made from a composition that is substantially hydrophilic but has lost at least part of its hydrophilicity, and the treating can be effective to restore hydrophilicity to at least a portion of the textile as evidenced by, prior to said treating, the textile exhibits a water contact angle of greater than 90 degrees and, after said treating, the performance textile exhibits a water contact angle of less than 90 degrees.

Improving performance of the textile can include reducing an ability of bacteria to adhere to the textile.

Improving performance of the textile can include reducing an ability of bacteria to remain adhered to the textile during laundering of the textile.

The textile can comprise a synthetic fabric.

The composition further can comprise at least one surfactant.

Treating the textile can comprise laundering the textile and adding the composition as part of the laundering.

Treating the textile can comprise spraying, wiping, or rolling the composition onto the textile.

In one or more embodiments, the present disclosure can particularly relate to laundry detergent compositions. Such compositions can be configured to exhibit a substantially low water content while still exhibiting the ability to provide improved performance to clothing items laundered using the compositions. For example, such compositions can comprise: at least one surfactant; at least one builder; a soil release polymer; and an aqueous base in an amount of about 1% to 15% by weight based on the total weight of the detergent composition; wherein the laundry detergent composition is configured for deposition of at least a portion of the soil release polymer onto at least a portion of surface of a textile when the textile is laundered using the laundry detergent; and wherein the soil release polymer is effective to cause said at least a portion of the surface of the textile to exhibit increased hydrophilicity. In further embodiments, such compositions may be further defined in relation to one or more of the following statements, which may be combined in any number and order.

The soil release polymer can be a poly(ethyleneoxide)-based polymer.

The poly(ethyleneoxide)-based polymer can be a copolymer of polyethylene terephthalate and polyoxyethylene terephthalate.

The soil release polymer can be present in an amount of about 0.5% to about 5% by weight based on the total weight of the detergent composition.

The aqueous base can be present in an amount of about 1% to about 7% by weight based on the total weight of the detergent composition.

The composition further can comprise baking soda.

The composition can be in a unit dose form and is enclosed in a water-soluble, film-forming material.

In one or more embodiments, the present disclosure can relate to compositions that can be effective for improving performance of a textile. Such compositions can be provided in a form including a relatively high water content to enable ease of application to individual articles of clothing. For example, such compositions can comprise: an aqueous base in an amount of about 50% to about 99% by weight; and at least one soil release polymer in an amount of about 0.1% to about 10% by weight; wherein the foregoing weights are based on the total weight of the composition. In further embodiments, such compositions may be provided as a spray-on formulation, a wipe-on formulation, or a roll-on formulation suitable for treating a single textile item at a time.

In some embodiments, the present disclosure further can relate to methods for providing a textile with one or more improved performance characteristics. For example, such methods can comprise: treating at least a portion of the textile with a composition comprising about 1% to about 99% by weight of water and about 0.1% to about 10% by weight of at least one soil release polymer, said weights being based on the total weight of the composition; and maturing the so-treated textile so that at least a portion of the at least one soil release polymer remains attached to the textile; wherein the presence of the at least one soil release polymer attached to the textile is effective to modify hydrophilicity of the textile. Maturing can include further process steps wherein the soil release polymer is allowed to develop improved adherence to the textile, and this can include heated drying (e.g., in a drying machine), open air drying (e.g., on a clothes line), or drying under ambient conditions (e.g., leaving the item handing or laying under ambient conditions to effect drying). In further embodiments, such methods may be further defined in relation to one or more of the following statements, which may be combined in any number and order

The modification in hydrophilicity can be evidenced in that, prior to said treating, the textile exhibits a wicking rate of less than 10 mm²/second and, after said treating, the textile exhibits a wicking rater of greater than 10 mm²/second when tested utilizing AATCC 198: Test Method for the Horizontal Wicking of Textiles.

The modification in hydrophilicity can be evidenced in that, prior to said treating, the textile exhibits a water contact angle of greater than 90 degrees and, after said treating, the performance textile exhibits a water contact angle of less than 90 degrees.

The modification in hydrophilicity can be evidenced in that the textile exhibits a reduction in an ability of bacteria to adhere thereto.

The modification in hydrophilicity can be evidenced in that the textile exhibits a reduction in an ability of bacteria to remain adhered to the textile during laundering of the textile.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

### BRIEF DESCRIPTION OF THE DRAWINGS

Having thus described the disclosure in the foregoing general terms, reference will now be made to the accompanying drawings, which are not necessarily drawn to scale, and wherein:

FIG. 1 shows a two-dimensional drawing of the copolymer comprising polyethylene terephthalate and polyethylene oxide terephthalate (“PET-POET”).

FIG. 2 depicts the results of a wash test showing the improvement in detergency of sebum from textiles using compositions according to example embodiments of the present disclosure.

FIG. 3 is a box plot showing the results for detergency of oils after one wash cycle of pretreatment using compositions according to example embodiments of the present disclosure. “LLD” represents a liquid laundry detergent formulation. “UDD” represents a unit dose detergent formulation.

FIG. 4 is a box plot showing the results for detergency of oils after three wash cycles of pretreatment using compositions according to example embodiments of the present disclosure. “LLD” represents a liquid laundry detergent formulation. “UDD” represents a unit dose detergent formulation.

FIG. 5 is a box plot showing the results for detergency of oils after five wash cycles of pretreatment using compositions according to example embodiments of the present disclosure. “LLD” represents a liquid laundry detergent formulation. “UDD” represents a unit dose detergent formulation.

FIG. 6 shows the measurements of malodor from fabric swatches before and after treatment of the fabric with compositions according to example embodiments of the present disclosure.

FIG. 7 shows changes in wicking rate of a textile before and after treatment with compositions according to example embodiments of the present disclosure.

FIG. 8 shows a bar chart quantifying the results of the bacteria adhesion test on textiles that were untreated or were treated using compositions according to example embodiments of the present disclosure.

### DETAILED DESCRIPTION OF THE DRAWINGS

The present disclosure now will be described more fully hereinafter with reference to the accompanying drawings. The disclosure may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural references unless the context clearly dictates otherwise.

In one or more embodiments, the present disclosure can provide compositions that are useful in providing improved treatment of various textiles, including a variety of fabrics, such as clothing and garments. The compositions can be provided in a variety of forms, such as detergent compositions that are typically utilized in laundering process, but also as refreshing compositions and similar formulations that may be applied to textiles separate from a typical laundering process. In all such implementations, the present compositions can provide benefits arising from the inclusion of a least a soil release additive. The compositions thus can be adapted to or configured to increase the hydrophilicity of a textile treated therewith through deposition of a portion of the soil release additive onto a surface of the treated textile. The soil release additive then can function as substantially a protective layer on the textile surface to reduce or prevent adhesion of soiling materials to the textile surface and/or reduce or prevent adhesion of odor-causing bacterial to the textile surface. The improvement in hydrophilicity can also protect and/or rejuvenate certain types of synthetic textiles that are adapted or configured to be moisture wicking. Such high performance fabrics can lose hydrophilicity through common laundering processes, and the use of the present compositions may be effective to restore and/or improve hydrophilicity to such fabrics.

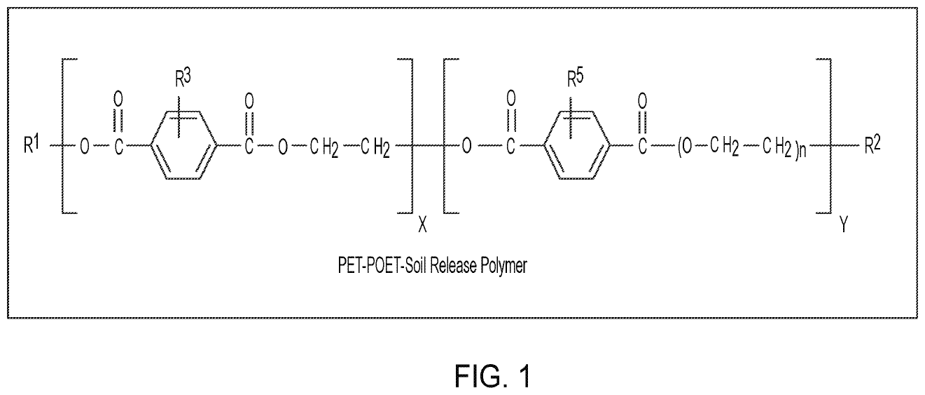

The soil release additive to be included in the present compositions can be any material that is adapted to or configured to be deposited on a surface of a textile and impart hydrophilic characteristics thereto. Suitable soil release additives, for example, can contain nonionic, anionic, zwitterionic, or ampholytic surface active agents or mixtures thereof. These soil release additive particularly can comprise an oligomeric ester backbone and one or more end-capping units. Suitable soil release additives specifically can be anionic. In example embodiments of the present disclosure, the soil release additive can be a polymer. More particularly, a suitable soil release polymer can be a poly(ethyleneoxide)-based polymer. In some embodiments, the poly(ethyleneoxide)-based polymer can be a copolymer of polyethylene terephthalate and polyoxyethylene terephthalate as illustrated in FIG. 1. The use of a copolymer comprising polyethylene terephthalate and polyethylene oxide terephthalate (“PET-POET”) has been of particular interest. Suitable soil release polymers for use according to the present disclosure are described, for example, in U.S. Pat. No. 4,785,060, to Nagler, U.S. Pat. No. 5,415,807, to Gosselink, et. al, U.S. Pat. No. 3,962,152, to Nicol, et. al., U.S. Pat. No. 4,132,680, to Nicol, U.S. Pat. No. 635,891, to Gabriel, et. al., U.S. Pat. No. 4,740,326, to Hortel, U.S. Pat. No. 5,451,341, to White, U.S. Pat. No. 3,959,230, to Hays, and U.S. Pat. App. Pub. No. 2013/0000052, to Peeters, et. al., the disclosures of which are incorporated herein by reference in their entireties.

One or more soil release additives, particularly soil release polymers, can be included in fabric care compositions of the present disclosure, which compositions can be provided in a variety of forms. The present compositions may be provided in solid and/or liquid forms, may be provided substantially as a laundry detergent composition (e.g., liquid, gel, or powder), may be provides in a bulk form or in a unit dosage form (e.g., forms known as a “pod” or “pods”), may be provided as a roll-on or wipe-on composition, and/or may be provided as a spray-on, pump, or aerosolized composition (e.g., a “refresher” composition). As such, the present compositions be configured for application directly to a textile or for application to one or more textiles in a typical laundering process (e.g., is a washing machine). Beneficially, the compositions, regardless of form, can be effective for improving performance of the treated items, such as to remove odors, to reduce adhesion of odor-causing chemical, to improve hydrophilicity and thus wicking ability, and provide other benefits in addition to the stain-fighting ability that is known to be associated with such soil release additives.

As a non-limiting example, a copolymer of polyethylene terephthalate and polyoxyethylene terephthalate that may be useful according to the present disclosure is commercially available from Clariant as TexCare® polymer packages 170, 172, and 260. Similar polymers are also available from Solvay, S.A. as Repel-O-Tex®.

The soil release polymers may be adapted to or configured to form a protective layer on a surface of a textile so as to be effective to at least partially prevent soil and/or bacterial adhesion to the treated textile. In some embodiments, the soil release polymers can be adapted to or configured to increase hydrophilicity of the treated textile, such as by adhering to a surface of the textile and providing hydrophilic groups at the treated surface. Additionally, or alternatively, the soil release polymers may be effective to at least partially restore hydrophilic groups that were previously present in the textile, such as in the case of certain synthetic fabrics, such as polyesters and similar fabrics. Without wishing to be bound by theory, the application of the soil release polymers onto a textile surface may arise at least in part from an affinity between the chemical structure of the soil release polymers and the composition of one or more fiber types present in the textile. For example, bonding may occur between a soil release polymer and one or more fibers forming the textile through π-π interaction between one or more aromatic rings in the soil release additive and the targeted fibers.

In some embodiments, the application of a layer of the soil release polymers onto a surface of a textile may be temporary such that the protective layer may be removed during a typical laundering process. In particular, the layer of the soil release polymers on the textile may be desorbed in a water wash cycle as the presence of a soil removal polymers can have an affinity for the wash liquid. Likewise, any soiling agents and/or bacteria that may be adhered to the soil release polymers will be removed during the wash cycle as well. A new protective layer of the soil release polymers may be applied to the textile. For example, when the soil release polymer is present in a detergent composition, the new layer can be added during the wash cycle.

In addition to improving the detergency of detergent formulations, the addition of a soil release polymer can be particularly effective to prevent or reduce bacterial adhesion to the textile and/or to improve the ability to remove such bacteria during a typical wash process. In this manner, the present compositions can be effective to reduce odor on various types of textiles, including clothing items. Synthetic fabrics composed of, for example, polyester or a polyester blend, used in athletic clothing are known to develop a strong, reoccurring, and unpleasant smell that can persist through the wash cycle. This smell is primarily due to human sweat, and other body soils such as skin cells, salts, and sebum, that remain embedded in the fibers of the clothing after the garments are washed. The malodor is then generated from a combination of biological and chemical processes that occur as the garment ages and through its continuous use. The biological process is the generation of malodorous compounds by bacteria on the fabric from body soils that act as a food source. Chemically, the direct absorption of human body malodors generating from carboxylic acids, sulfur, and nitrogen containing compounds from contact with the skin in combination with any volatile chemicals native to the clothing materials are known mechanisms responsible for the increased malodor. See, for example, Chamila, J., et. al., “Source, Impact, and Removal, of Malodour from Soiled Clothing”, J. Chromatogr. A 1438 (2016), 216-225. The hydrophilic groups of the soil release polymers can be effective to bond with common types of malodorous chemicals that form on the body through natural processes. Such bonding can effectively sequester the chemicals to prevent or reduce odor evolution and/or may chemically modify the odor-causing chemicals to reduce or prevent the odor evolution. Moreover, such interactions can improve the ability to remove the odor-causing chemicals during a typical laundering process.

The soil release polymers may be present in the present compositions in a variety of concentrations. In some embodiments, a composition may include a soil release polymer in an amount of about 0.01% to about 15% by weight based on the total weight of the composition. In further embodiments, the soil release polymer may be present in an amount of about 0.1% to about 10%, about 0.25% to about 5%, or about 0.5% to about 2.5% by weight based on the total weight of the composition.

Compositions according to the present disclosure that incorporate at least one soil release polymer or similar soil release additive can be particularly useful for improving performance of textiles. This can extend to any item formed of woven or non-woven fibers, particularly fabrics and clothing items made from such fabrics. Textile performance as used herein can reference any advanced function apart from the basic covering of the body. In particular, performance can relate to wicking ability, hydrophilicity, or the ability of the article to move moisture (e.g., sweat) away from the body of the user to be easily evaporated. Thus, performance may relate to an ability to impart a sense of cooling or rapid drying to the user. Because sweat typically can transfer some amount of bacteria therewith, performance may further relate to an ability to resist binding of bacteria and/or an ability to improve removal of bacteria from the article. Because odors are often associated with such bacteria and/or other components of sweat, performance also may relate to an ability to inhibit odor in an article and/or an ability to improve odor removal from the article.

In some embodiments, the present disclosure thus can provide methods for improving performance of a textile, such methods comprising treating the textile with a composition including a soil release polymer in an amount effective to modify hydrophilicity of the textile. As further shown in the examples appended hereto, testing has shown that hydrophobic textiles can be treated according to the present disclosure so as to have hydrophilicity imparted thereto. Such imparting of hydrophilicity may be evidenced, for example, by an increase in wicking rate of the textile. In a similar manner, testing has shown that performance can be improved for textiles that were originally prepared to be a performance article (e.g., exhibiting good wicking ability) but has lost at least part of the performance ability due to routine laundering, routine wear, or non-routine damage to the textile surface. Thus, a hydrophilic textile that has lost hydrophilicity or a hydrophobic textile that has lost a hydrophilic-imparting treatment may be rejuvenated, revitalized, or simply improved in relation to performance characteristics as described herein through treatment with compositions according to the present disclosure.

In some embodiments, a substantially hydrophobic textile may be characterized has having a wicking rate below a defined threshold when tested using AATCC 198: Testing Method for the Horizontal Wicking of Textiles (see, the American Association of Textile Chemists and Colorists). The defined threshold for a textile being said to be substantially hydrophobic and/or as having insufficient wicking ability to be considered a performance textile can be a wicking rate of less than 10 mm²/second, less than 8 mm²/second, or less than 6 mm²/second. Such characterization may also apply to a textile that has previously been treated to exhibit hydrophilicity but has lost such ability as noted above. After treatment with a composition according to the present disclosure, such textile may be exhibit an improvement in hydrophilicity as evidenced by having a wicking rate showing the textile to be substantially hydrophilic and/or to meet a minimum standard to be considered a performance textile. Such wicking rater can be greater than 10 mm²/second, greater than 12 mm²/second, or greater than 14 mm²/second, such as in the range of about 11 mm²/second to about 20 mm²/second or about 13 mm²/second to about 20 mm²/second when tested utilizing AATCC 198. In further embodiments, improvements in hydrophilicity (either a new treatment of a substantially hydrophobic textile or a rejuvenation of a hydrophilic textile that has exhibited degraded performance ability) may be characterized in relation to further testing. For example, in some embodiments, a textile may be characterized as being substantially hydrophobic or as lacking sufficient hydrophilicity to be considered to be a performance article when the textile exhibits a water contact angle of greater than 90 degrees. The water contact angle can be a measure of the ability of water to wick or spread across a textile and thus define the ability of the textile to move the liquid efficiently for evaporation. In some embodiments, a threshold for hydrophilicity can be a water contact angle of greater than 90 degrees, greater than 100 degrees, or greater than 110 degrees. Likewise, textiles exhibiting a lower water contact angle can be considered to exhibit sufficient wicking ability to efficiently move liquid through the textile for rapid evaporation. A water contact angle sufficiently low to be characterized in this manner can be a water contact angle of less than 90 degrees, less than 85 degrees, less than 80 degrees, or less than 70 degrees. Textiles having an unacceptably high water contact angle thus can be improved in one or more performance characteristics by treatment with compositions according to the present disclosure, and such improvement can be readily evaluated using testing methods such as those noted above and described in the appended examples.

In one or more embodiments, compositions according to the present disclosure can be in the form of a laundry detergent comprising one or more soil removal polymers. Beneficially, the addition of soil release polymers as discussed above can be effective to improve the cleaning power of such detergent compositions. In some embodiments, the addition of a soil removal polymer can significantly affect the rheology of liquid detergent compositions, such as by reducing the viscosity of the system. Without wishing to be bound by theory, the reduction in viscosity can be caused when the soil release polymer interferes with the surfactant aggregates that generate the viscosity of such liquid detergents. Such lowered viscosity can be troublesome in that some consumers may equate cleaning ability with liquid viscosity and have an unsupported presupposition that a more viscous liquid detergent provides better cleaning efficacy or detergency. With the rise in unit dose formulations, such concerns are not raised due to the reduced interaction between the consumer and the bulk product. On the other hand, reduced viscosity can improve the ability of the detergent composition to quickly disperse is a washer. Thus, in some embodiments, lower viscosity liquid detergent compositions can exhibit improved detergency. This can particularly be seen in formulations that include a soil release polymer, a reduced water content, and a lower concentration of active ingredients in the wash liquor when compared to a high water composition. Another benefit of liquid detergent formulations that include a soil release polymer is that once a textile (e.g., a garment or clothing item) is washed with a detergent formulation comprising the soil release polymers, the polymer can be effective to form substantially a protective layer on the treated surface that can increase surface hydrophilicity. The presence of the added hydrophilic surface groups can be effective to improve the cleaning of hydrophobic soils as well as reducing bacterial adhesion, which can be a cause of malodor in garments and other textiles.

In one or more embodiments of the present disclosure, a laundry detergent composition can comprise at least one surfactant, at least one builder, and at least one soil release polymer. Such detergent compositions particularly can be in a liquid form and thus can further comprise an aqueous base. The aqueous particularly can be water, such as deionized or simply purified water; however, other aqueous bases (e.g., buffered solutions, etc.) may be utilized. In some embodiments, a detergent composition according to the present disclosure can comprise about 1% to about 15%, about 2% to about 10%, or about 3% to about 7% by weight of the aqueous base based on the total weight of the detergent composition. Beneficially, the soil release polymer can be adapted to or configured to increase the cleaning power of the laundry detergent composition. Further beneficially, the laundry detergent composition can be configured for deposition of at least a portion of the soil release polymer onto a surface of a textile when the textile surface is contacted with the laundry detergent. In some embodiments, the soil release polymer can be adapted to or configured to cause at least a portion of the treated surface to be hydrophilic or exhibit increased hydrophilicity.

Further compositions according to the present disclosure can likewise include an aqueous base. In one or more embodiments, compositions according to the present disclosure, such as refresher compositions, pre-treatment compositions, spray-on cleaners, and the like may include a higher percentage of the aqueous base. For example, a liquid composition according to the present disclosure may include an aqueous base in an amount of about 1% to about 99% by weight, based on the total weight of the composition. A relatively high water composition may include about 50% to about 99%, about 55% to about 98%, about 65% to about 97%, or about 75% to about 95% by weight of an aqueous base, based on the total weight of the composition. A relatively low water composition may include about 1% to about 45%, about 2% to about 40%, about 3% to about 30%, or about 5% to about 20% by weight of an aqueous based, based on the total weight of the composition. Such ranges can apply to one or more detergent compositions and/or to one or more further types of compositions as otherwise described herein.

Laundry detergent compositions according to the present disclosure can comprise one or more surfactants effective for removal of various soiling materials from fabrics such as clothing, towels, and other textiles formed of natural and/or synthetic fibers, yarns, and woven and/or nonwoven fabrics made therefrom. The surfactant(s) may be defined in relation to be a “surfactant system,” which is understood to refer to the total package of surfactant(s) that are present in the composition. In some embodiments the surfactant system may comprise or consist of only a single type of surfactant while in other embodiments the surfactant system may comprise or consist of a plurality of different types of surfactants. Preferably the surfactant system of the laundry detergent compositions comprises one or both of an anionic surfactant and a nonionic surfactant. In some embodiments, the surfactant system may include one or more surfactants consisting of only anionic surfactants. In other embodiments, the surfactant system may include one or more surfactants consisting of only nonionic surfactants. In further embodiments, the surfactant system may include two or more surfactants consisting of only anionic and nonionic surfactants. The total content of surfactant system present in the laundry detergent composition can be about 2.0% to about 45%, about 3.0% to about 35%, about 4.0% to about 25%, about 5.0% to about 20%, about 6.0% to about 15%, or about 7.0% to about 15% by weight based on the total weight of the laundry detergent composition.

Anionic surfactants suitable for use according to the present disclosure can include those that are configured for removal of soiling agents, such as dirt, clay, and/or oily materials. In some embodiments, the anionic surfactant may be configured for at least partial deposition onto surfaces of items being laundered to provide resistance to re-deposition of soiling agents onto the items during the laundering process. The anionic surfactant retained on the surfaces of the laundered items can be removed therefrom during the rinse cycle of the laundering process. A wide variety of anionic surfactants may be used according to the present disclosure. In various embodiments, a suitable anionic surfactant may include one or more salts (e.g., sodium, potassium, ammonium, and substituted ammonium salts such as mono-, di- and triethanolamine salts) of anionic sulfates, sulfonates, carboxylates, and sarcosinates. Exemplary anionic sulfates can include linear and/or branched primary and secondary alkyl sulfates, alkyl ethoxysulfates, fatty oleoyl glycerol sulfates, alkyl phenol ethylene oxide ether sulfates, C₅-C₁₇ acyl-N-(C₁-C₄ alkyl) and —N-(C₁-C₂ hydroxyalkyl) glucamine sulfates, and sulfates of alkylpolysaccharides, such as alkylpolyglucoside sulfates. Exemplary alkyl sulfates can include linear and branched primary C₁₀-C₁₈ salkyl sulfates. Exemplary alkyl ethoxysulfate surfactants can include C₁₀-C₁₈ alkyl sulfates that have been ethoxylated with from 0.5 to 20 moles of ethylene oxide per molecule. Exemplary anionic sulfonate surfactants can include salts of C₅-C₂₀ linear alkylbenzene sulfonates (for example, Biosoft® S-118 sold by Stepan Company), alkyl ester sulfonates, C₆-C₂₂ primary or secondary alkane sulfonates, C₆-C₂₄ olefin sulfonates, sulfonated polycarboxylic acids, alkyl glycerol sulfonates, fatty acyl glycerol sulfonates, fatty oleyl glycerol sulfonates, and any mixtures thereof. Exemplary anionic carboxylates can include alkyl ethoxy carboxylates, and alkyl polyethoxy polycarboxylates. In some embodiments, preferred anionic surfactants can include various sulfates (e.g., alkyl ether sulfates, such as laureth sulfate salts), alkyl ester sulfonates, and alkylbenzene sulfonate (e.g., C₅ to C₂₀ or C₁₀ to C₁₆). Non-limiting examples of anionic surfactants that may be used herein include sodium laureth sulfate (SLES, for example, Steol® 25-2S.70 CIT sold by Stepan Company), sodium lauryl sulfate (SLS), methyl ester sulfonate (MES), and sodium C₁₀₋₁₆ alkylbenzene sulfonate (LAS). In certain embodiments, ethoxylated anionic surfactants may be utilized and may comprise a limited number of moles of ethylene oxide groups. For example, an alkyl ether sulfate anionic surfactant may comprise less than 5 moles, or less than 4 moles of ethylene oxide groups, such as 1 to 4 or 2 to 3 ethylene oxide groups. A single anionic surfactant may be utilized or a plurality of anionic surfactants (e.g., 2, 3, 4, or more) may be used. The total content of anionic surfactant(s) present in the laundry detergent composition can be 0% to about 45%, about 2.0% to about 45%, about 3.0% to about 35%, about 4.0% to about 25%, about 5.0% to about 20%, about 6.0% to about 15%, or about 7.0% to about 15% by weight based on the total weight of the laundry detergent composition. In some embodiments, such as where a nonionic surfactant may be preferred, the composition may be defined in relation to being expressly free of any anionic surfactants. When both an anionic and nonionic surfactants are present, it can be preferable for the anionic surfactant(s) to be present in a total concentration of about 0.1% to about 25%, about 1% to about 20%, about 2% to about 15%, or about 5% to about 15% by weight based on the total weight of the laundry detergent composition.

Nonionic surfactants suitable for use according to the present disclosure likewise can include those that are configured for removal of soiling agent as described above, and particularly those that can improve removal of oily materials on the laundered items. A wide variety of nonionic surfactants may be used according to the present disclosure. In various embodiments, a suitable nonionic surfactant may include alkyl ethoxylate condensation products of aliphatic alcohols with from 1 to 25 moles of ethylene oxide wherein the alkyl chain of the aliphatic alcohol can either be straight or branched, primary or secondary, and generally contains from 6 to 22 carbon atoms. Further suitable nonionic surfactants can include water soluble ethoxylated C₆-C₁₈ fatty alcohols and C₆-C₁₈ mixed ethoxylated/propoxylated fatty alcohols. For example, the ethoxylated fatty alcohols can be C₁₀-C₁₈ ethoxylated fatty alcohols with a degree of ethoxylation of from 3 to 20. In some embodiments, mixed ethoxylated/propoxylated fatty alcohols can have an alkyl chain length of from 10 to 18 carbon atoms, a degree of ethoxylation of from 3 to 30, and a degree of propoxylation of from 1 to 10. In further embodiments, suitable nonionic surfactants can include those formed from the condensation of ethylene oxide with a hydrophobic base formed by the condensation of propylene oxide with propylene glycol. Examples of compounds of this type include certain of the commercially-available Pluronic™ surfactants, marketed by BASF. Further, suitable nonionic surfactants can include those formed from the condensation of ethylene oxide with the product resulting from the reaction of propylene oxide and ethylenediamine. Examples of this type of nonionic surfactant include certain of the commercially available Tetronic™ compounds, marketed by BASF. In certain embodiments, suitable nonionic surfactants can be selected, for example, from various alcohol ethoxylates. In some embodiments, the nonionic surfactant can be defined in relation to the alcohol chain length and/or the number of ethoxylate groups present in the molecule. For example, the nonionic surfactant can comprise an alcohol ethoxylate formed from an alcohol with a carbon chain length of 3 to 20 carbon atoms, 5 to 20 carbon atoms, 7 to 19 carbon atoms, 9 to 18 carbon atoms, 10 to 17 carbon atoms, or 12 to 15 carbon atoms. As a further example, the nonionic surfactant can comprise an alcohol ethoxylate having 2 to 10, 4 to 9, or 6 to 8 moles of ethylene oxide per mole of alcohol. Non-limiting examples of nonionic surfactants that may be used herein include ethoxylated alcohols (AE) (C₁₂₋₁₅ alcohols, in particular), such as those available under the tradename NEODOL®, lauryl or myristyl glucosides (APG), and polyoxyethylene alkylethers (2° AE). A single nonionic surfactant may be utilized or a plurality of nonionic surfactants (e.g., 2, 3, 4, or more) may be used. The total content of nonionic surfactant(s) present in the laundry detergent composition can be about 0% to about 45%, about 2.0% to about 45%, about 3.0% to about 35%, about 4.0% to about 25%, about 5.0% to about 20%, about 6.0% to about 15%, or about 7.0% to about 15% by weight based on the total weight of the laundry detergent composition. In some embodiments, such as where an anionic surfactant may be preferred, the composition may be defined in relation to being expressly free of any nonionic surfactants. When both an anionic and nonionic surfactants are present, it can be preferable for the nonionic surfactant(s) to be present in a total concentration of about 0.1% to about 25%, about 1% to about 20%, about 2% to about 15%, or about 5% to about 15% by weight based on the total weight of the laundry detergent composition. Further, in some embodiments, the laundry detergent composition may be expressly free of any amphoteric surfactants.

Laundry detergent compositions according to the present disclosure further can comprise one or more builders. In some embodiments, suitable builders may be effective as alkalinizing agents. In some embodiments, suitable builders may be effective as viscosifiers. In some embodiments, a single builder may be utilized as both an alkalinizing agent and a viscosifier. For example, various alkali carbonates and/or other inorganic alkalinizing agents may be utilized to increase the pH of the laundry detergent composition while simultaneously increasing the viscosity to a desired level. Preferably, sodium and/or potassium salts (e.g., K₂CO₃ and/or Na₂CO₃) may be used. For example, soda ash can be used. Preferably, a builder, such as soda ash, is utilized in an amount effective to increase composition pH above the pH of substantially pure water in light of the high content of aqueous base that is utilized in the present compositions. In some embodiments, the laundry detergent composition thus can be provided with a composition pH that is sufficiently high to assist in inhibiting microbial growth as well as improving cleaning efficacy. In some embodiments, however, it may be desirable to maintain pH below a defined level to assist in maintaining stability of the soil release polymer. Preferably, in a composition including the soil release polymer, the composition pH will be about 8.5 or less, such as about 6 to about 8.5, about 6.5 to about 8.5, or about 7 to about 8.5. In some embodiments, however, such as in the case of unit dose formulations, the soil release polymer may be compartmentalized from one or more further components of the composition. As such, a portion of the composition including the soil release polymer may have a pH as defined above, and a portion of the composition not including the soil release polymer may be compartmentalized from the remaining portion, and such portion not including the soil release polymer may have a higher pH as desired.

In one or more embodiments of the present disclosure, a laundry detergent composition can be provided in a unit dose form and can be enclosed in a water-soluble film-forming material. As used herein, terms such as “package”, “pod”, “pouch”, and the like can be used interchangeably to describe the water-soluble film forming the article enclosing liquid laundry detergents described herein. The water-soluble film-forming material is in substantially direct contact with the liquid laundry detergent, with the film-forming material maintaining its structural integrity prior to external contact with an aqueous medium, such as a laundry wash liquor. The liquid detergent is capable of remaining homogeneous over a relatively wide temperature range, such as might be encountered in storage, and the pouch is capable of dissolution in water even after extended storage.

In some embodiments, the water-soluble film-forming material can preferably be made from polyvinyl alcohol, but can also be cast from other water-soluble materials such as polyethylene oxide, methyl cellulose and mixtures thereof. Suitable water-soluble films are well known in the art and are commercially available from numerous sources. Further, it is known to form pouches or pods with a plurality of compartments, the contents of which remain separated until dissolution of the pouch material. This, it is possible according to the present disclosure to provide a laundry detergent composition in a multi-compartment, pouched form wherein at least a soil release polymer is present in one compartment, and wherein at least one further component of the laundry detergent is present in at least one or more further compartments.

In some embodiments, the inclusion of a soil release polymer as described above can be effective to modify the viscosity of a liquid detergent composition. For example, the inclusion of the soil release polymer can be effective to reduce the viscosity of the liquid laundry detergent composition system by interfering with the surfactant aggregates that generate the viscosity of such liquid detergent compositions. These reduced-viscosity liquid detergent systems can exhibit improved cleaning power in laundry formulations containing a soil removal polymer in a low water detergent formulation and lower concentration of active ingredients in the wash liquor. For example, liquid detergent in a high water unit dose form may contain a higher concentration of active ingredients that would result in better cleaning power. Instead, a low water detergent formulation comprising a soil release polymer can exhibit improved cleaning power despite having a lower concentration of active materials than in a high water system. The addition of a soil removal polymer may cause the formulation, for example in a unit dose, to become more homogenous under low viscosity which leads to a more stable formulation. In some embodiments, it thus can be useful to provide a unit dose laundry detergent according to the present disclosure with a substantially low content of aqueous base as already described above.

If desired, one or more further components may also be utilized in the present compositions. In some embodiments of the present disclosure, the various compositions can further comprise baking soda. Other non-limiting examples of further materials that can be included in the presently disclosed compositions can comprise betaine and amino-oxide type surfactants, chelator(s), enzyme(s), enzyme stabilizer(s), dye(s), optical brightener(s), antiredeposition polymer(s), fluorescent whitening agent(s), fragrance(s), buttering agent(s), thickener(s), antifoaming agent(s), pH adjustor(s), bleach(es), fabric softener(s), pearl luster agent(s), preservative(s), and the like. In general, such additional ingredients in the present compositions can be included, independently, in an amount of 0% to about 4.0%, about 0.01% to about 3.0%, about 0.02% to about 2.0%, or about 0.05% to about 1.0% by weight based on the total weight of the composition.

In one or more embodiments, the present disclosure further can provide methods for modifying a surface of a textile. In particular, the disclosure can relate to method for refreshing a textile, including methods for improving the hydrophilicity of a surface of a textile. For example, methods according to the present disclosure can comprises contacting a surface of a textile with a composition as otherwise described herein. Specifically, the composition can include a soil release polymer, and the composition may be in the form of a refresher composition, a cleaning composition, a detergent composition, and the like. Preferably, the contacting is sufficient so that at least a portion of the soil release polymer is deposited onto the surface of the textile in an amount effective to increase hydrophilicity of the textile surface. The contacting may be via spraying, rolling, wiping, or otherwise applying the composition directly to the textile surface. In some embodiments, the contacting may be via processing the textile in a laundering method, such as a typical washing of the textile in a washing machine (or hand washing) utilizing a detergent composition as described herein.

Compositions according to the present disclosure that are particularly useful for direct application to individual items (e.g., as a pretreatment formulation, as a spray-on refresher composition, or the like) may be formulated with a substantially high water content for ease of use thereof. As example embodiments, such compositions may include an aqueous base in the range of about 50% to about 99% by weight based on the total weight of the composition and at least one soil release polymer in the range of about 0.1% to about 10% by weight based on the total weight of the composition. In some embodiments, such composition may consist of only an aqueous base and one or more soil release polymers. Alternatively, such compositions may expressly exclude typical detergent components, such as surfactants, builders, and the like. If desired, materials such as fragrance may be included as an indicator that the treated textile has been refreshed.

In some embodiments, treatment of a textile may be limited to treatment of only certain portions of an article. For example, it may be desirable to treat only the under-arm area of an article of clothing to improve wicking and drying in such area. Thus, the present methods may be limited to only application to a portion of an article of clothing instead of application to the entire article.

Treating of an article according to the present disclosure likewise may include a maturing step. Because the compositions may be provided in an aqueous base, application can leave the textile wet or damp in the area of application. As such, the textile may be matured to allow the soil release polymer to properly bind to the fibers of the article. Maturing may include processing the article in a heated or non-heated, mechanical drier. Maturing may include subjecting the article to ambient conditions for a time sufficient for the aqueous base to evaporate and leave the polymer material behind, substantially bound or adhered to the textile, and specifically to fibers forming the textile. In some embodiments, maturing may include rinsing the treated textile in substantially plain water to remove non-polymer components.

In one or more embodiments of the disclosure, the textile can comprise a fabric, and particularly an article of clothing, that is formed at least in part from a synthetic fiber. Non-limiting examples of synthetic fibers include acrylic, polyester, Kevlar®, modacrylic, Nomex®, Spandex (Lycra®) Nylon, and Rayon, and combinations thereof. In further embodiments, natural fibers, such as cotton, may also be subject to treatment according to the disclosure.

### EXPERIMENTAL

### Example 1—Sebum Removal

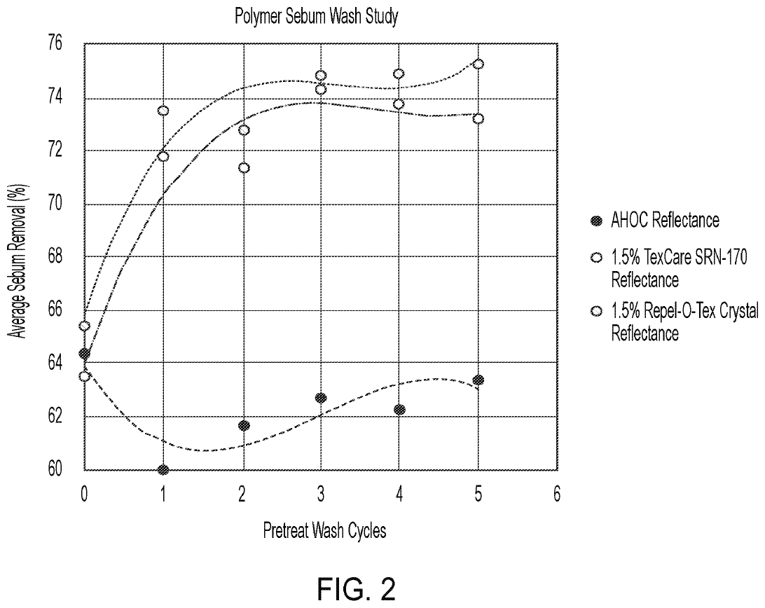

The performance of a liquid laundry detergent formulation according to the present disclosure was measured as a function of sebum removal. The test composition was prepared by modifying the commercially available liquid laundry detergent, Arm and Hammer Plus Oxiclean Fresh Scent (AHOC), to include 1.5% by weight of a soil release polymer (PET-POET polymer). Swatches formed of Polyester (87%)/Lycra (13%) available from Scientific Services were used and were washed with the laundry detergent alone (noted as AHOC in FIG. 2), laundry detergent plus 1.5% by weight of TexCare® 170 soil release polymer (“TexCare SRN 170 in FIG. 2), or laundry detergent plus 1.5% by weight Repel-O-Tex® soil release polymer (“Repel-O-Tex Crystal” in FIG. 2). The dosage was 51.83 g of detergent per wash, and the testing was carried out utilizing ASTM D4265-14 (Standard Guide for Evaluating Stain Removal Performance in Home Laundering). FIG. 2 shows the results of the wash test with the polymers. The “pretreat wash cycles” referenced in FIG. 2 represents the number of wash cycles the swatches experienced before the application of the sebum to the swatches. For example, pretreat wash cycle of ‘0’ means that swatch did not undergo any pretreatment while a pretreat wash cycle of ‘5’ means that swatches were washed (and air dried) through 5 cycles before the soil was applied. Each point is an average of 4 replicates. The wash test showed a clear improvement in the removal of sebum with a detergent formulation containing a soil release polymer.

### Example 2—Cleaning Power

The cleaning power of a liquid laundry detergent containing the soil release polymer was compared to a unit dose detergent pod containing the soil release polymer. The liquid laundry detergent (“LLD”) used in the testing was the same as the formulations used in Example 1. The formulation for the unit dose detergent (“UDD”) used in the testing is shown in Table 1 below. A dosage of 51.8 g was used for the LLD, which is based on the bottle recommendations and the detergent density. This was compared to a dosage of 44 g for the UDD, which is equivalent to approximately 2 pods.

TABLE 1
Example of the unit dose formulation with the polymers
at 1.5% active level. To make room for the polymer,
the appropriate amount of DPG was removed.

| | | Mod 3 |
|---|---|---|
| Treatment | Ingredient | Wt % |
| All | Neodol 25-7 | 42.648 |
| | DPG (Dipropylene Glycol) | 14.88 |
| | Glycerin | 4.4 |
| | Neodol 23-2 | 12 |
| | Water | 6.9 |
| | Steol 25-3S?70FC (70%) | 3.98 |
| | MEA | 2.4 |
| | Biosoft S-118 (96% DBSA) | 10 |
| | Palm Kernel Fatty Acid | 1.25 |
| | Bitrex | 0.042 |
| | Fragrance | 0 |
| A | TexCare SRN 170 | 1.5 |
| B | Repel-O-Tex Crystal | |

| | |
|---|---|
| Total | 100 |

In this test, the soil used was Spangler's Sebum emulsion from Scientific Services, which is recommended by the ASTM test method for detergency. The test was again carried out using ASTM D4265-14. Additionally, all swatches were pretreated in the same way by washing them for a number cycles in the designated composition (LLD or UDD) before applying the soil. This provided opportunity for the soil release polymer to be deposited on the fabric to allow for identification of the number of washes typically required until effectiveness reached a relative maximum. Sebum removal was measured by color difference between the soiled, washed, and virgin fabrics. A summary of the data for the treated samples (4 replicates of each treatment) is shown in Table 2 with a trend for the liquid unit dose formulation to be more effective in cleaning sebum from the fabric.

TABLE 2
Data summary of for the cleaning performance of the
different detergent forms including the soil release
polymer at 1.5% in the formulation. (LLD—Liquid
Laundry Detergent, UDD—Unit Dose Detergent)

| | Detergency (Stain Removal % per g Detergent) | | | |
|---|---|---|---|---|
| | TexCare SRN170 | | Repelotex Crystal | |
| Wash Cycles | LLD | UDD | LLD | UDD |
| 1 | 1.41 | 1.53 | 1.43 | 1.66 |
| | 1.42 | 1.68 | 1.46 | 1.65 |
| | 1.38 | 1.57 | 1.42 | 1.63 |
| | 1.34 | 1.55 | 1.37 | 1.60 |
| 3 | 1.47 | 1.60 | 1.44 | 1.68 |
| | 1.43 | 1.68 | 1.44 | 1.67 |
| | 1.43 | 1.64 | 1.45 | 1.65 |
| | 1.40 | 1.61 | 1.47 | 1.64 |
| 5 | 1.41 | 1.68 | 1.47 | 1.65 |
| | 1.42 | 1.61 | 1.46 | 1.68 |
| | 1.40 | 1.64 | 1.45 | 1.64 |
| | 1.42 | 1.65 | 1.44 | 1.62 |

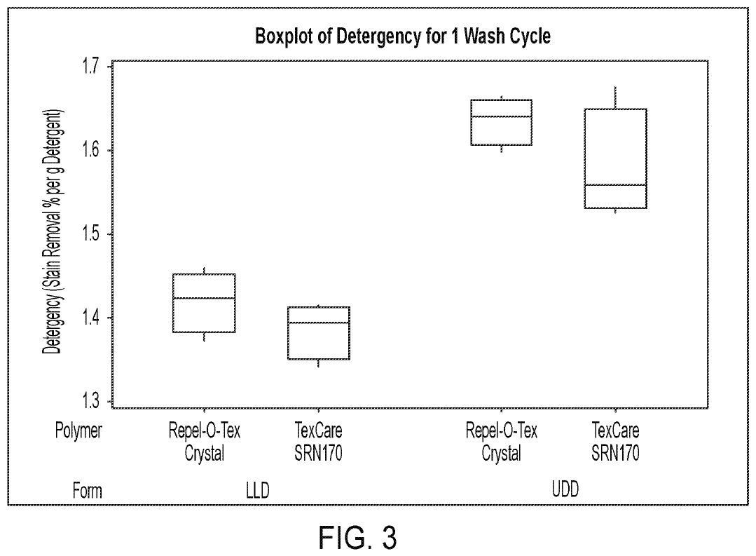

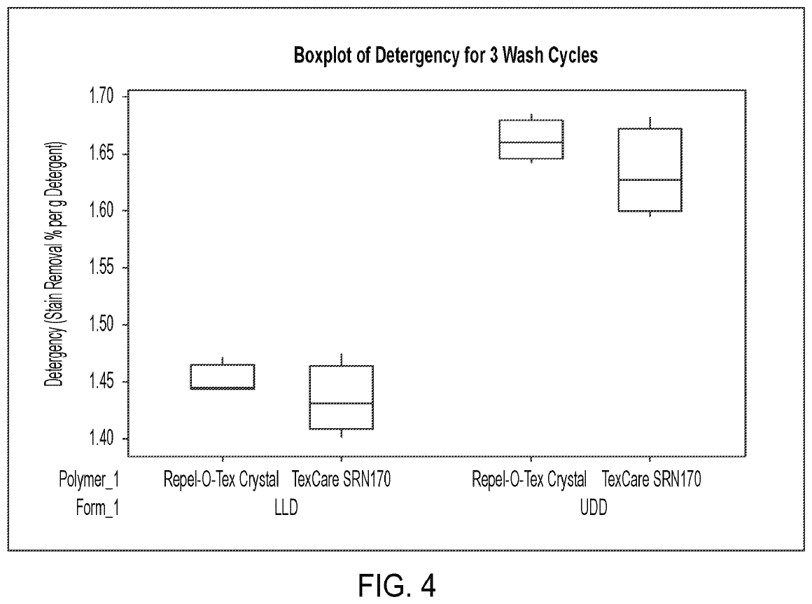

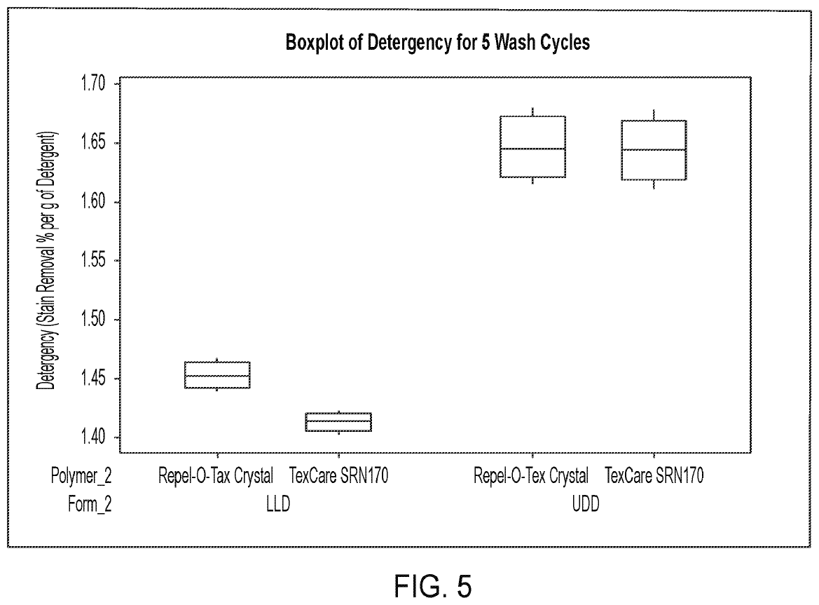

The unit dose formulation (UDD) was shown to exhibit improved cleaning relative to the liquid formulation (LLD) in all cases. However, the results were not significant for the different polymers, which suggests that both TexCare SRN170 and Repel-O-Tex perform similarly. This result is also shown graphically in the boxplots shown in FIGS. 3-5. The cleaning performance improved from one to three was cycles of pretreatment. No additional cleaning benefit was observed at five wash cycles which indicated that maximum deposition of the soil release polymer occurred after three washes.

While there was a clear benefit to oily soil detergency in the liquid laundry detergent formulation, testing also revealed that the PET-POET polymers had a negative impact on composition viscosity. Because of the problem with the rheology of the detergent, the impact of more concentrated detergent formulations, such as the liquid unit dose formulation, was also evaluated. The reduced amount of water in these formulations avoided the problem with the ingredient on the composition viscosity. Thus, it was shown that the form of the detergent will impact the performance of the soil release polymer with the more concentrated form of the liquid, such as the unit dose formulation, being more effective at cleaning.

### Example 3—Perceived Malodor Intensity

Opacity measurements were utilized to evaluate the ability of the present compositions to reduce or eliminate malodors. To carry out the testing, 20 mg of a mixture of the triglycerides triacetin and tributyrin were applied to a synthetic fabric swatch comprising 87% polyester/13% Lycra®. The sample with the triglycerides thereon was sprayed with a 1% lipase solution and tested for malodor generation from the breakdown of the triglycerides into their fatty acids—acetic acid and butyric acid. Prior to application of the triglycerides, the fabric was treated with various concentrations of soil release polymer (TexCare® SRN 170) in deionized water (0% to 5% soil release polymer).

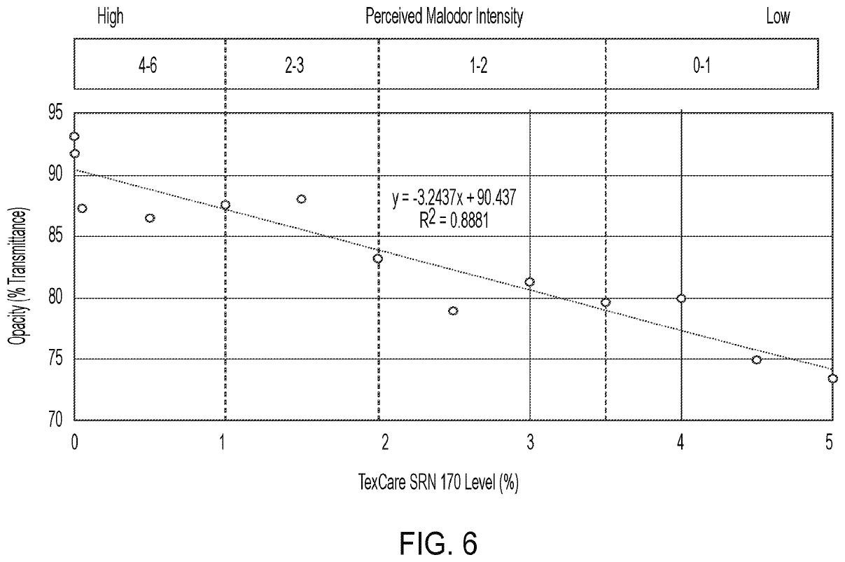

FIG. 6 shows that agitation in deionized water for 30 seconds reduced the perceived malodor intensity as the concentration of the soil release polymer increased. The perceived malodor was substantially eliminated at the 4-5% level of soil release polymer. The malodor was evaluated by a panel of four non-experts.

### Example 4—Improved Textile Performance

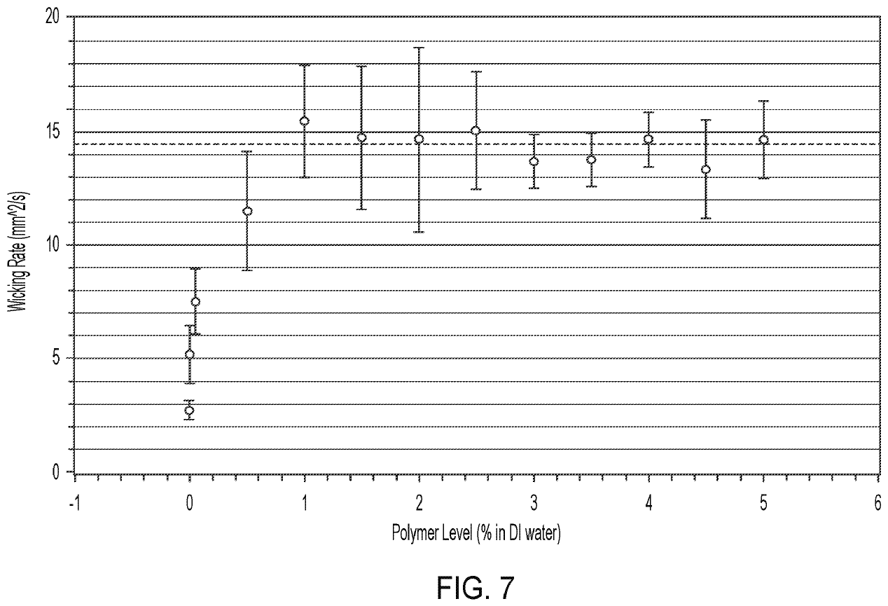

Testing was carried out to evaluate the ability to improve performance of a textile through treatment with a composition including a soil release polymer in an amount effective to modify hydrophilicity of the textile. Testing was first carried out using a hydrophobic textile, a fabric formed from 87% PET and 13% Lycra® sourced from Scientific Services. The fabric samples were untreated or treated with a composition including PET-POET polymer in deionized water at levels ranging from 0.5% to 5% by weight. Improvements in hydrophilicity were evaluated utilizing test method AATCC 198: Test Method for the Horizontal Wicking of Textiles, which measures the wicking rate in units of area per second for a drop of liquid applied to the fabric surface. As seen in the test results provided in FIG. 7, improvement in the wettability of the fabric (e.g., as evidenced by wicking rate) was achieved at levels that are the same as experienced through a standard laundering cycle in a top loading washing machine (i.e., approximately 0.1%). This change became more substantial as the percent of PET-POET polymer applied increased. The improvement was thus shown to be suitable for use in laundering conditions as well as individual applications, such as through use of a spray, roll-on, or the like (e.g., a pre-treatment directly with a detergent or application through a fabric refresher spray). As seen in FIG. 7, in the absence of the PET-POET polymer, the hydrophobic fabric exhibited a wicking rate of less than 10 mm²/second, less than 8 mm²/second, less than 6 mm²/second, and less than 4 mm²/second in the various samples tested. After treating, the textile exhibited a wicking rater of greater than 10 mm²/second and greater than 13 mm²/second, specifically being generally in the range of about 12 mm²/second to about 20 mm²/second.

Testing was next carried out to evaluate the ability to improve hydrophilicity of a hydrophilic textile that has been damaged through routine wear, washing, and the like so that the performance of the textile has been reduced from its original state. The testing was carried out utilizing two commercially available clothing items made of athletic material with hydrophilic modified, synthetic fibers. These included a pair of athletic pants available from Nike, Inc. and described as a stretchy fabric with Dri-FIT technology that moves sweat from skin. These also included a Champion short sleeve tee shirt made from 100% polyester and including Double Dry® technology that wicks sweat away from the body.

An eight-inch embroidery hoop was place around the outside of either the groin or arm pit region of the tested fabric so that it was slightly stretched to provide the flattest possible surface for testing. The fabric was abraded using a 120 grit fine sanding sponge, and the abrading was done by lightly sanding the pertinent section of the fabric for at least 30. Consistency of abrasion was evaluated by both visual inspection of the area and testing of wettability of the fabric per the methods of Good, R., Contact Angle, Wettability, and Adhesion: A Critical Review, J. Adhes. Sci. Technol., 1992 6 (12), 1269-1302. Specifically, to evaluate wettability, a single drop of deionized water from a transfer pipette was placed in different regions of the area of abrasion, and the contact angle of the water droplet on the fabric surface was evaluated. On the abraded fabric, water did not wet the fabric as was evidenced by a water contact angle of greater than 90 degrees. Visually, the abraded fabric had a “fuzzy” appearance due to significant pilling on the fabric surface. The abraded fabrics were next treated with a composition including 1% by weight or 5% by weight of the PET-POET polymer. The polymer solution was applied directly to a localized area of the damaged fabric and then air dried prior to again evaluating water contact angle. After treatment with the polymer, the contact angle was reduced to less than 90 degrees for both tested fabrics at both polymer concentrations, and the water spread on the surface of the fabric to substantially the same the same degree as when the fabric was provided new and non-abraded.

Finally, textile performance was evaluated in relation to the ability of the fabric to resist adhesion of bacteria. Synthetic fabric formed from 87% PET and 13% Lycra® was purchased from Scientific Services and pretreated with a 3% solution of soil release polymer before being inoculated with bacteria, subjected to washing, and then stained for evaluation. More particularly, each fabric sample was soaked for one hour in the 3% polymer solution and air dried. A control fabric of the same material was soaked in a solution having the same overall composition but excluding the soil release polymer and then air dried. Once dry, both fabrics were inoculated with a population of bacteria (Staphylococcus aureus). Both the treated and untreated fabric were washed with deionized water and then stain utilizing a composition configured to reveal any live bacteria remaining on the fabric. The number of bacteria remaining on the swatch was then measured by a colorimeter and through visual inspection.

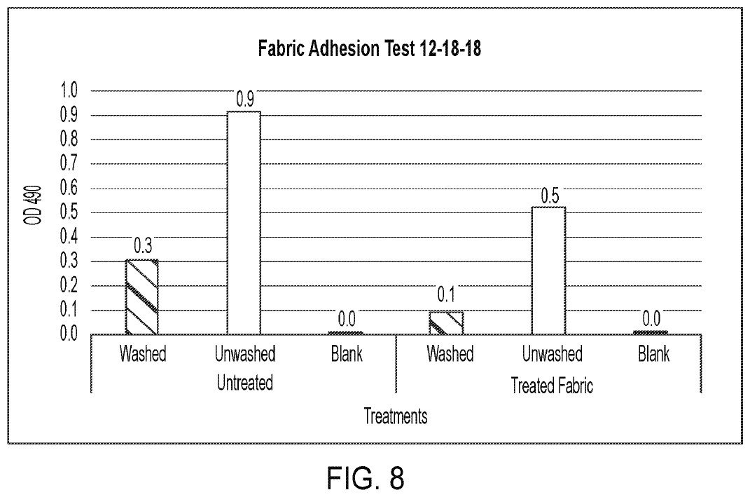

Evaluation revealed that the samples that were treated with the soil release polymer exhibited a measurable reduction in the number of bacteria initially adhering to the swatch before washing, which contributed to lower microbe growth on the fabric. This showed that the polymer significantly improved the fabric resistance to bacteria adhesion without being subjected to the wash cycle. The evaluation further revealed that the number of bacteria remaining on the swatches after washing was lower for the polymer treatment. This further demonstrated the polymer maintained the reduction in bacteria adhesion through the wash cycle. The testing thus showed that the treatment of the textile with the soil release polymer provided protection against bacteria transfer to the athletic garments initially and also improved the ability to remove any transferred bacteria during the wash cycle. These results are illustrated in FIG. 8.

### Example 5—Stability

Testing was carried out to evaluate long-term stability of detergent compositions including soil release polymer when the composition is a concentrated formulation, such as with unit dose pods. Various detergent compositions including the soil release polymers TexCareSRN 170, TexCareSRN 172, TexCareSRN 260, and Repel-O-Tex Crystal (all being PET-POET polymers) were prepared with some being stored in glass containers and other being enclosed in a film to form unit dose pods. The samples were monitored for room temperature stability for three months. The tested formulations are shown in TABLE 3.

TABLE 3

| | | Control | Mod A | Mod B | Mod C |
|---|---|---|---|---|---|
| Treatment | Ingredient | Wt % | Wt % | Wt % | Wt % |
| All | Neodol 25-7 | 42.648 | 42.648 | 42.648 | 42.648 |
| | DPG (Dipropylene | 16.46 | 15.88 | 15.38 | 14.88 |
| | Glycol) | | | | |
| | Glycerin | 4.4 | 4.4 | 4.4 | 4.4 |
| | Neodol 23-2 | 12 | 12 | 12 | 12 |
| | Water | 6.9 | 6.9 | 6.9 | 6.9 |
| | Steol 25-3S?70FC | 3.98 | 3.98 | 3.98 | 3.98 |
| | (70%) | | | | |
| | MEA | 2.4 | 2.4 | 2.4 | 2.4 |
| | Biosoft S-118 | 10 | 10 | 10 | 10 |
| | (96% DBSA) | | | | |
| | Palm Kernel | 1.25 | 1.25 | 1.25 | 1.25 |
| | Fatty Acid | | | | |
| | Bitrex | 0.042 | 0.042 | 0.042 | 0.042 |
| | Fragrance | 0 | 0 | 0 | 0 |
| 1 | TexCare SRN 170 | 0 | 0.5 | 1 | 1.5 |
| 2 | TexCare SRN 172 | | | | |
| 3 | TexCare SRN 260 | | | | |
| 4 | Repel-O-Tex Crystal | | | | |

| | | | | |
|---|---|---|---|---|
| Total | 100 | 100 | 100 | 100 |

After 3 months of incubation at room temperature, the liquid formulation was observed for changes in clarity and color. Visual inspection was used to compare the polymer modified formulations with a control formulation. Failure of the test was determined if there was a loss of clarity, phase separation, and/or a significant change in the color. For the liquid formulations, all of the modified formulations, which included soil release polymers in the range of 0.5-1.5% w/w, passed the 3-month stability test. While some formulations, such as those including TexCare SRN260 and Repel-O-Tex Crystal were lighter than the control formulation, there was no observed change in clarity and no observed phase separation.

The liquid formulations were observed to show some visual changes when enclosed in the polyvinyl alcohol films as a pod. In particular, the TexCareSRN 260 polymer failed the stability test upon visual inspection because it became turbid with solid material observed in the formulation. Along with the phase separation, the film itself seemed to lose integrity when compared to the control samples. The Repel-O-Tex Crystal was also slightly turbid, but there was no observable phase separation and the film integrity seemed to be similar to the control. Because of the maintenance of the pod film integrity and lack of phase separation, the Repel-O-Tex Crystal was still considered to pass the 3-month stability test. There were no visual indications of problems with TexCareSRN 170 or 172. For TexCareSRN 170, there was an increase in pod stiffness as the polymer level concentration increased. In general, changes in the pod integrity and the formulation clarity/color are indications of an interaction with the pod film.

All the formulations were observed to pass stability when stored outside the pod film, but TexCareSRN 260 and Repel-O-Tex Crystal showed some lightening of the color. In the pod, TexCareSRN170 and TexCareSRN172 passed the 3-month room temperature stability test for the liquid formulation and pod integrity, but TexCareSRN 260 failed both tests. Repel-O-Tex Crystal was given a tentative passing score for pod integrity, but it should be noted that the color of the formulation in the pod is lighter than the control with slight turbidity. There was no visible phase separation with the Repel-O-Tex Crystal. Thus, only TexCareSRN 170 & 172 show full compatibility and long-term stability in a concentrated formulation that is useful for liquid unit dose pods.

Many modifications and other embodiments of the disclosure will come to mind to one skilled in the art to which this disclosure pertains having the benefit of the teachings presented in the foregoing description; and it will be apparent to those skilled in the art that variations and modifications of the present disclosure can be made without departing from the scope or spirit of the disclosure. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for improving performance of a textile, the method comprising treating the textile with a composition including a soil release polymer in an amount effective to modify hydrophilicity of the textile, said modification in hydrophilicity being evidenced at least one of the following:
prior to said treating, the textile exhibits a wicking rate of less than 10 mm²/second and, after said treating, the textile exhibits a wicking rate of greater than 10 mm²/second when tested utilizing AATCC 198: Test Method for the Horizontal Wicking of Textiles; and
prior to said treating, the textile exhibits a water contact angle of greater than 90 degrees and, after said treating, the performance textile exhibits a water contact angle of less than 90 degrees.

2. The method of claim 1, wherein the soil release polymer is a poly(ethyleneoxide)-based polymer.

3. The method of claim 2, wherein the poly(ethyleneoxide)-based polymer is a copolymer of polyethylene terephthalate and polyoxyethylene terephthalate.

4. The method of claim 1, wherein the soil release polymer is present in the composition in an amount of about 0.1% to about 10% by weight based on the total weight of the composition.

5. The method of claim 1, wherein the composition comprises an aqueous base in an amount of about 1% to about 45% by weight based on the total weight of the composition.

6. The method of claim 1, wherein the composition comprises an aqueous base in an amount of about 50% to about 99% by weight, based on the total weight of the composition.

7. The method of claim 1, wherein the composition further comprises at least one surfactant.

8. The method of claim 1, wherein the textile is made from a composition that is substantially hydrophobic, and wherein the treating is effective to impart hydrophilicity to at least a portion of the textile as evidenced by, prior to said treating, the textile exhibiting a wicking rate of less than 10 mm²/second and, after said treating, the textile exhibiting a wicking rater of greater than 10 mm²/second when tested utilizing AATCC 198: Test Method for the Horizontal Wicking of Textiles.

9. The method of claim 1, wherein the textile is made from a composition that is substantially hydrophilic but has lost at least part of its hydrophilicity, and wherein the treating is effective to restore hydrophilicity to at least a portion of the textile as evidenced by, prior to said treating, the textile exhibits a water contact angle of greater than 90 degrees and, after said treating, the performance textile exhibits a water contact angle of less than 90 degrees.

10. The method of claim 1, wherein improving performance of the textile includes reducing an ability of bacteria to adhere to the textile.

11. The method of claim 1, wherein improving performance of the textile includes reducing an ability of bacteria to remain adhered to the textile during laundering of the textile.

12. The method of claim 1, wherein the textile comprises a synthetic fabric.

13. The method of claim 1, wherein treating the textile comprises laundering the textile and adding the composition as part of the laundering.

14. The method of claim 1, wherein treating the textile comprises spraying, wiping, or rolling the composition onto the textile.

15. A laundry detergent composition comprising:
at least one surfactant;
at least one builder;
a soil release polymer; and
an aqueous base in an amount of about 1% to 15% by weight based on the total weight of the detergent composition;
wherein the laundry detergent composition is configured for deposition of at least a portion of the soil release polymer onto at least a portion of surface of a textile when the textile is laundered using the laundry detergent; and
wherein the soil release polymer is effective to cause said at least a portion of the surface of the textile to exhibit increased hydrophilicity.

16. The composition of claim 15, wherein the soil release polymer is a poly(ethyleneoxide)-based polymer.

17. The composition of claim 16, wherein the poly(ethyleneoxide)-based polymer is a copolymer of polyethylene terephthalate and polyoxyethylene terephthalate.

18. The composition of claim 15, wherein the soil release polymer is present in an amount of about 0.5% to about 5% by weight based on the total weight of the detergent composition.

19. The composition of claim 15, wherein the aqueous base is present in an amount of about 1% to about 7% by weight based on the total weight of the detergent composition.

20. The composition of claim 15, further comprising baking soda.

21. The composition of claim 15, wherein the composition is in a unit dose form and is enclosed in a water-soluble, film-forming material.

22. A composition effective for improving performance of a textile, the composition comprising:
an aqueous base in an amount of about 50% to about 99% by weight; and
at least one soil release polymer in an amount of about 0.1% to about 10% by weight;
wherein the foregoing weights are based on the total weight of the composition; and
optionally wherein the composition is a spray-on formulation, a wipe-on formulation, or a roll-on formulation suitable for treating a single textile item at a time.

23. (canceled)

24. A method for providing a textile with one or more improved performance characteristics, the method comprising:
treating at least a portion of the textile with a composition comprising about 1% to about 99% by weight of water and about 0.1% to about 10% by weight of at least one soil release polymer, said weights being based on the total weight of the composition; and
maturing the so-treated textile so that at least a portion of the at least one soil release polymer remains attached to the textile;
wherein the presence of the at least one soil release polymer attached to the textile is effective to modify hydrophilicity of the textile.

25. The method of claim 24, wherein said modification in hydrophilicity is evidenced by one or more of the following:
prior to said treating, the textile exhibits a wicking rate of less than 10 mm²/second and, after said treating, the textile exhibits a wicking rater of greater than 10 mm²/second when tested utilizing AATCC 198: Test Method for the Horizontal Wicking of Textiles;
prior to said treating, the textile exhibits a water contact angle of greater than 90 degrees and, after said treating, the performance textile exhibits a water contact angle of less than 90 degrees;
the textile exhibits a reduction in an ability of bacteria to adhere thereto;
the textile exhibits a reduction in an ability of bacteria to remain adhered to the textile during laundering of the textile.

26-28. (canceled)
